(19) United States
(12) Patent Application Publication
(10) Pub. No.: US 2015/0024898 A1
(43) Pub. Date: Jan. 22, 2015

(54) Planetary Gear Set with Improved Performance and a Method of Producing a Ring Gear

(71) Applicant: Apex Brands, Inc., Sparks, MD (US)

(72) Inventor: Stephen P. Radzevich, Lexington, SC (US)

(21) Appl. No.: 13/943,332

(22) Filed: Jul. 16, 2013

(51) Int. Cl. F16H 1/28

(52) U.S. Cl. CPC F16H 1/28
USPC 475/331

(57) ABSTRACT

An improved planetary gear set that includes a sun gear, planet gears, and a ring gear. The ring gear is constructed to radially deform under an operating load. Therefore, the gear set is constructed such that the base pitches of the sun gear, planet gears, and the deformed ring gear under the operating load are equalized. The ring gear is further constructed with tooth profiles designed to accommodate the deflection under the operating load. The tooth profile of the ring gear is designed using an operating pitch diameter instead of a nominal pitch diameter to accommodate the deflection.

### BACKGROUND

The present application is directed to a planetary gear set and, more particularly, to a planetary gear set designed to account for the alteration of the base pitch of the ring gear that occurs under an operating load.

Planetary gear sets include one or more planet pinions that move about a central sun gear. The planet pinions are rotatably mounted on a carrier which may also rotate relative to the central sun gear. An outer ring gear extends around the exterior of these elements and includes teeth that mesh with the planet pinions.

During use, the sun gear, planet pinions, and ring gear mesh with one another. To enhance meshing of the gear teeth, the base pitches of these gears should be equal to one another. The smaller the differences among the base pitches, the more accurate meshing of the teeth resulting in lower noise excitation, lower dynamic loading of the teeth, higher durability of the gear set, and improvement in various other performance parameters of the gear set.

A common problem with planetary gear sets is the inaccurate meshing of the teeth of the various gears. This includes a rough engagement of the gear teeth during meshing and a corresponding rough disengagement. The inaccurate meshing results in an excessive amount of noise. Further, this results in higher dynamic loading of the gear teeth that lessens the durability and the power density which is the amount of power the gear set is capable of transmitting.

Adding to the issues with meshing teeth is often times the ring gear is constructed in a manner that may be deformed under an operating load. This deformation causes a change in the base pitch of the ring gear resulting in inaccurate meshing of the teeth. Existing planetary gear sets do not accommodate for the deformation.

### SUMMARY

The present application is directed to a planetary gear set with a ring gear. The ring gear is constructed to account for the elastic deformation of the base pitch that occurs under an operating load.

One embodiment is directed to a planetary gear set that includes a sun gear, planet gears that mesh with the sun gear, and a ring gear with an annular body that extends around the sun gear and the planet gears and meshes with the planet gears. Each of the sun gear, the planet gears, and the ring gear have teeth that mesh together. The annular body of the ring gear is constructed from an elastically deformable material and has a first shape when no load is applied to the ring gear and a radially deformed second shape when a load is applied to the ring gear. The teeth of the ring gear have a first base pitch in the first shape and a different second base pitch in the second shape. The second base pitch of the ring gear is equal to base pitches of the sun gear and the planet gears.

The axes of the sun gear, the planet gears, and the ring gear may be parallel.

The planetary gear set may also include a carrier with axial shafts that each extend through an interior of one of the planet gears.

The ring gear may include a greater operating pitch diameter in the second shape than in the first shape.

The teeth of the ring gear may be based on an operating pitch diameter of the second shape to accommodate for deflection.

Another embodiment is directed to a planetary gear set that include a sun gear, planet gears that mesh with the sun gear, and a ring gear that extends around the sun gear and the planet gears and meshes with the planet gears. Each of the sun gear, the planet gears, and the ring gear include teeth that mesh together. The annular body is elastically deformable under an operating load. The base pitch of the deformed ring gear is equal to base pitches of the sun gear and the planet gears.

The annular body may include a first nominal shape and a second deformed shape under the operating load.

A radius of curvature of the ring gear may be greater in the second deformed shape than in the first nominal shape.

The ring gear may include a greater operating pitch diameter in the second deformed shape than in the first nominal shape.

The axes of the sun gear, the planet gears, and the ring gear may be parallel.

The planetary gear may also include a carrier with axial shafts that each extend through an interior of one of the planet gears.

Another embodiment is directed to a planetary gear set that includes a sun gear, planet gears that mesh with the sun gear, and a ring gear that extends around the sun gear and the planet gears and meshes with the planet gears. Each of the sun gear and the planet gears maintain their shapes under an operating load. The ring gear includes a body that flexes radially under the operating load and has an operating pitch diameter under the operating load that is greater than a nominal pitch diameter without the operating load. Each of the sun gear, the planet gears, and the ring gear has teeth that mesh together. The tooth profile of the ring gear is based on the operating pitch diameter to accommodate the deflection. The teeth of the sun gear, the planet gears, and the ring gear under the operating load have equal base pitches.

The ring gear may be constructed from a material such that the ring gear elastically deforms under the operating load.

The axes of the sun gear, the planet gears, and the ring gear may be parallel.

The planetary gear may also include a carrier that includes axial shafts that each extend through an interior of one of the planet gears.

The various aspects of the various embodiments may be used alone or in any combination, as is desired.

### BRIEF DESCRIPTION OF THE DRAWINGS

FIG. 1 is an exploded view of a planetary gear set.

FIG. 2 is a schematic top view of a planetary gear set.

FIG. 3 is a schematic view of a non-deformed and a deformed ring gear.

FIG. 4 is a schematic view of a non-deformed and a deformed ring gear.

FIG. 5 is a schematic view of a deformed ring gear during a manufacturing process.

### DETAILED DESCRIPTION

The present application is directed to an improved planetary gear set. The planetary gear set includes a sun gear, planet pinions, and a ring gear. The ring gear is constructed in a manner that radially elastically deforms under an operating load. Therefore, the gear set is constructed such that the base pitches of the sun gear, planet pinions, and the deformed ring gear under the operating load are equalized. The ring gear is further constructed with tooth profiles designed to accommodate the deflection under the operating load. The tooth profile of the ring gear is designed using the operating pitch diameter instead of the nominal pitch diameter to accommodate the deflection.

Planetary gear sets include one or more planet pinions that revolve around a central sun gear. The planet pinions may be mounted on a carrier that may also rotate relative to the sun gear. An outer ring gear extends around the members and meshes with the planet pinons. Planetary gear sets may include a simple configuration that includes a single sun, one or more planet pinions, a ring gear, and a carrier. Compound configurations include a more complex grouping of elements to provide larger reduction ratios and higher torque-to-weight ratio.

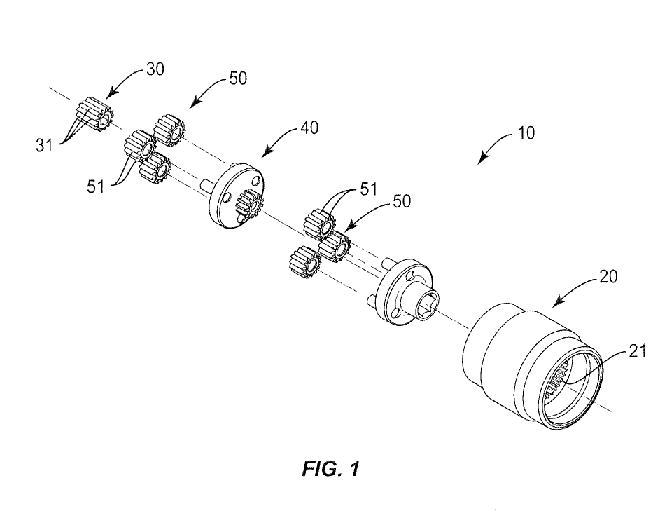

FIG. 1 illustrates an embodiment of a compound planetary gear set 10 with a double-stage arrangement. The gear set 10 includes a ring gear 20 with teeth 21, a sun gear 30 with teeth 31, a carrier 40, and two sets of planet pinions 50 each with teeth 51. These elements are configured with an axis of rotation of the sun gear 30 being aligned with an axis of rotation of the carrier 40. The axis of rotation of the sun gear is further aligned with the axis of rotation of the ring gear 20. In one embodiment, the axes of rotation of the elements are parallel.

The gear set 10 may be designed such that the sun gear 30, the ring gear 20, or the carrier 40 is either driven or is driving. The gear set 10 may further be designed with either the sun gear 30, the ring gear 20, or the carrier 40 is stationary.

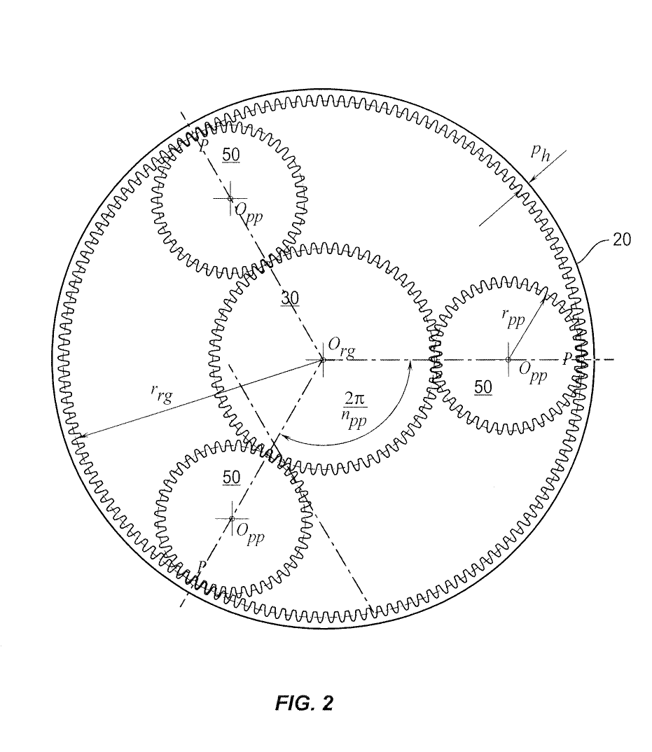

FIG. 2 illustrates a configuration of the ring gear 20, the sun gear 30, and three planet pinions 50 in a nominal condition under no operating load. The sun gear 30 and the planet pinions 50 are formed from a solid such that these elements do not elastically deform when placed under the operating load. Conversely, the ring gear 20 is formed from a relatively thin wall ring. The ring gear 20 includes a minimum wall thickness Pₕ and a pitch diameter d_{rg}. The diameter of the ring gear d_{rg} is equal to twice the radius (i.e., d_{rg}=2r_{rg}). The ring gear 20 includes a ratio h/d_{rg} with the smaller the ratio, the larger the deflection δ of the ring gear 20 under an operating load.

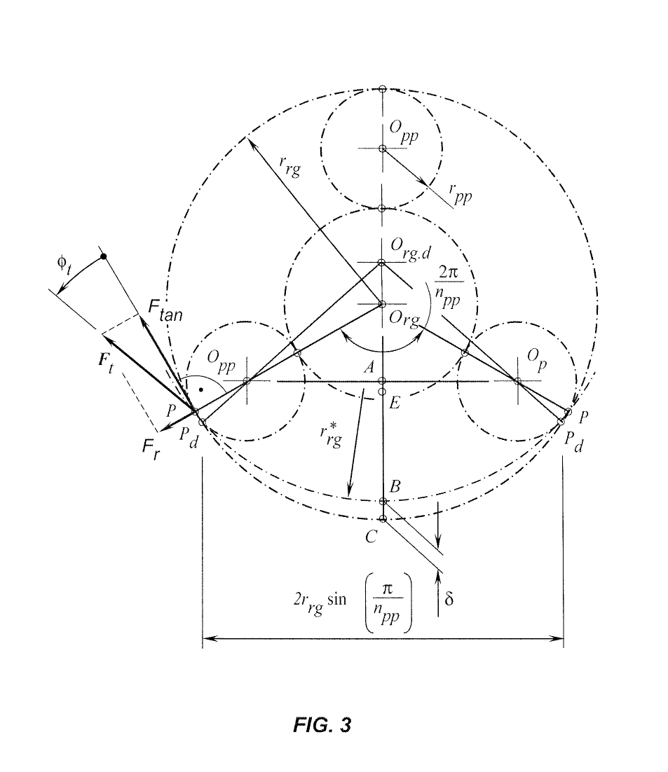

Elastic deformation of the ring gear 20 under the operating load is schematically illustrated in FIG. 3. For simplicity, only pitch circles of the ring gear 20, the sun gear 30, and the planet pinions 50 are depicted in FIG. 3. The radii of the pitch circle of the ring gear 20 is labeled as r_{rg}, and the pitch circle of the planet pinions 50 are labeled as rₚₚ.

In one embodiment, the planet pinions 50 are driving the ring gear 20. A tangential force Fₜ is acting from a tooth of the planet pinion 50 against a tooth of the ring gear 20 along the line of action. The line of action is a straight line through the pitch point P. The line of action is at a transverse pressure angle φₜ with respect to a perpendicular to the radial direction OₚₚO_{rg}.

Under zero operating loads, an arc of the ring gear pitch circle is a circular arc of radius r_{rg} through the points PCP. However, under the operating load Fₜ the circular arc PCP is deflected. The point C is displaced at a certain distance δ to a new position labeled as B. In the deformed state, the pitch line is a line through the points P_{d}BP_{d}. Evidently, radius of curvature r*_{rg} of the arc P_{d}BP_{d} at the point B is larger than the radius r_{rg}. Because of the inequality r*_{rg}>r_{rg}, the radius r*_{rg} is used in the following equations for the calculation of the base pitch. In this way, the base pitch of the ring gear 20 under the operating load Fₜ can be equal to base pitch of the mating planet pinion 50 (as well as of the meshing sun gear 30).

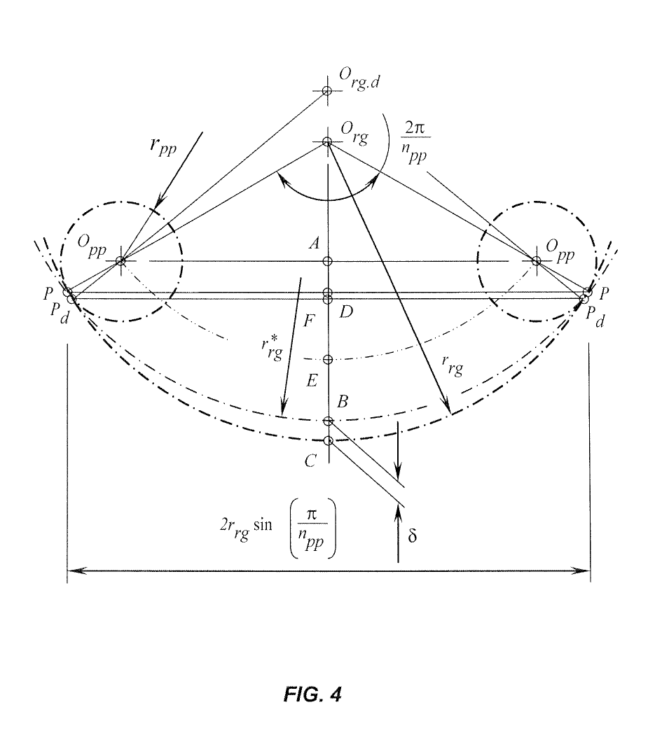

Further, alteration in pitch radius (namely, from r_{rg} to r*_{rg}) also requires corresponding changes to tooth profile of the ring gear 20. Assume that the line P_{d}BP_{d} is an arc of a circle of a certain radius r*_{rg} centering at a point O_{rg.d}. To calculate the appropriate corrections for the tooth profile of the ring gear 20, it is necessary to express the radius r*_{rg} of the ring gear 20 under the operating load in terms of design parameters of the gear set 10 under zero operating load. The following set of equations is used for the calculation of the radius r*_{rg} (see FIG. 4):

$$\begin{matrix}BC = δ & ( 1 ) \\ {AO}_{pp} = ( {r}_{rg} - {r}_{pp} ) sin \frac{π}{{n}_{pp}} & ( 2 ) \\ {AO}_{rg} = ( {r}_{rg} - {r}_{pp } ) cos \frac{π}{{n}_{pp}} & ( 3 ) \\ AC = {r}_{rg} - {AO}_{rg} = {r}_{rg} - ( {r}_{rg} - {r}_{pp} ) cos \frac{π}{{n}_{pp}} & ( 4 ) \\ AB = AC - δ = {r}_{rg} - ( {r}_{rg} - {r}_{pp} ) cos \frac{π}{{n}_{pp}} - δ & ( 5 ) \\ μ = \frac{{r}_{rg}^{*}}{{r}_{rg}^{*} - {r}_{pp}} & ( 6 ) \\ {O}_{pp} {O}_{rg} = {r}_{rg} - {r}_{pp} & ( 7 ) \\ α = \frac{π}{{n}_{pp}} & ( 8 ) \\ {AO}_{pp} = ( {r}_{rg} - {r}_{pp} ) sin α & ( 9 ) \\ {AO}_{rg} = ( {r}_{rg} - {r}_{pp} ) cos α & ( 10 ) \\ {P}_{d} F = μ {AO}_{pp} = μ ( {r}_{rg} - {r}_{pp} ) sin α & ( 11 ) \\ AD = {r}_{pp} cos α & ( 12 ) \\ CD = {r}_{rg} ( 1 - cos α ) & ( 13 ) \\ BC = δ & ( 14 ) \\ BE = {r}_{pp} & ( 15 ) \\ AE = ( {r}_{rg}^{*} - {r}_{pp} ) - \sqrt{{( {r}_{rg}^{*} - {r}_{pp} )}^{2} - {( {AO}_{pp} )}^{2}} & ( 16 ) \\ AE = ( {r}_{rg}^{*} - {r}_{pp} ) - \sqrt{{( {r}_{rg}^{*} - {r}_{pp} )}^{2} - {( {r}_{rg} - {r}_{pp} )}^{2} {sin}^{2} α} & ( 17 ) \\ {DO}_{rg} = {r}_{rg} cos α & ( 18 ) \\ AE = \underbrace{( CD + AD )}_{AC} - \underbrace{BE}_{{r}_{pp}} - \underbrace{BC}_{δ} & ( 19 ) \\ AE = {r}_{rg} ( 1 - cos α ) - \underbrace{{r}_{pp} cos α - {r}_{pp}}_{- {r}_{pp} ( 1 - cos α )} - δ & ( 20 ) \\ \begin{matrix}AE = ( {r}_{rg} - {r}_{pp} ) ( 1 - cos α ) - δ \\ = ( {r}_{rg}^{*} - {r}_{pp} ) - \sqrt{{( {r}_{rg}^{*} - {r}_{pp} )}^{2} - {( {r}_{rg} - {r}_{pp} )}^{2} {sin}^{2} α}\end{matrix} & ( 21 )\end{matrix}$$

On solving Equation (21) with respect to the radius r*_{rg}, an expression for the effective radius of the ring gear 20 under the operating load can be obtained in the following equation:

r*_{rg}=r*_{rg}(δ)

The function is not linear, however, it is very close to a linear function within the interval of practical interest. Further, the function r*_{rg}=r*_{rg}(r_{rg}) is also almost linear.

As it is clear from the above consideration, the ring gear tooth profile is developed from a base circle centering at O_{rg}. Under the operating load, the effective pitch circle is centering at O_{rg.d}. The offset O_{rg}O_{rg.d} affects the mesh between the ring gear 20 and the planet pinions 50. The offset O_{rg}O_{rg.d} makes it difficult or impossible for the base pitches of the ring gear 20 and of the planet pinions 50 to be equal. As a result, the planetary gear set 10 produces more noise and the gear teeth are subject to higher dynamic loads, which reduce durability of the gear set 10.

The ring gear 20 of the present application can be either broached or cut by a standard shaper cutter. When using a standard shaper cutter, the ring gear blank should be elastically deformed by δ. Once deformed, the blank is then cut. Once cut, the elastic deformation is released thus giving the ring gear 20 its desired geometry.

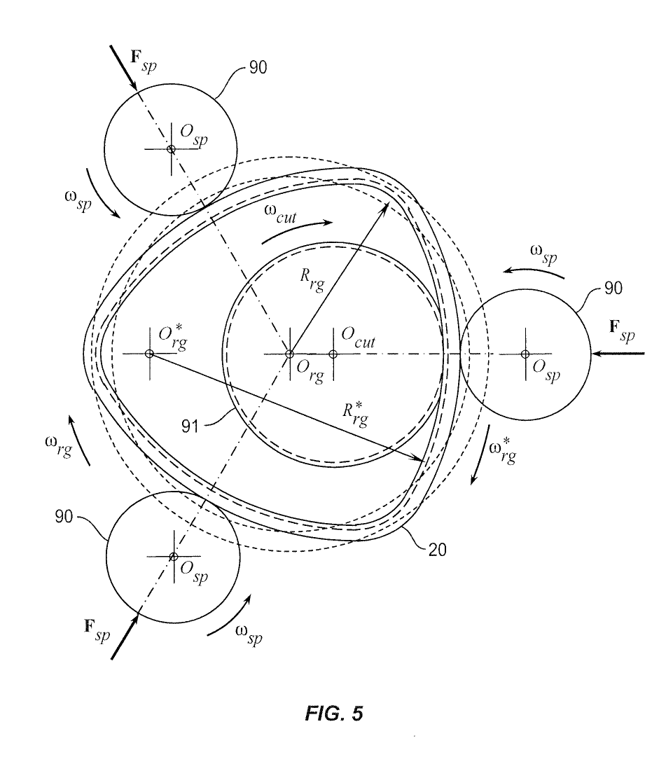

An intentional elastic deformation of the work is implemented when shaping the thin-wall ring gears 20. FIG. 5 illustrates a method of shaping the ring gear 20. As stated above, the thin-wall ring gears 20 are deformed by the operating loads during operation. When the deformation is large enough, the operating base pitch P_{b.op} of the ring gear 20 differs from that in the mating planet pinion 50 which causes one or more performance issues as stated above. The operating base pitches of mating gears should be equal to one another under the various circumstances. To obtain this equality, the ring gears 20 are cut while in a deformed state.

As illustrated in FIG. 5, a ring gear 20 of pitch radius r_{rg} is cut by a shaper cutter 91. The ring gear 20 is rotated about its axis of rotation O_{rg} at a constant angular velocity ω_{rg}. The shaper cutter 91 is rotated about its axis of rotation O_{cut} at a certain angular velocity ω_{cut}. The rotations ω_{rg} and ω_{cut} are timed with one another. During machining, the ring gear 20 is intentionally deformed to that same stage at which it is deformed when operating in the gear set 10. FIG. 5 illustrates the undeformed shape of the ring gear 20 in dashed lines and the elastically deformed ring gear 20 in solid lines.

Three rollers 90 can be used for the elastic deformation of the ring gear 20. The supporting rollers 90 are rotated about their axis of rotation Oₛₚ at an angular velocity ωₛₚ. The supporting rollers 90 are pressed into the ring gear 20 by radial forces Fₛₚ. Because of the applied forces Fₛₚ the ring gear 20 is elastically deformed to a state with an operating pitch radius r*_{rg}. The operating pitch radius r*_{rg} is larger than the radius r_{rg} of a non-deformed ring gear 20 (that is, the inequality r*_{rg}>r_{rg} is observed).

It could be imagined that a fake ring gear of pitch radius r*_{rg} is rotated about a fake axis of rotation O*_{rg} with a certain fake angular velocity ω_{rg}. The rotations of the ring gear 20 and of the shaper cutter 91 are timed with one another so to ensure equal linear velocities at the contact point of the circle of radii r*_{rg} and the pitch circle of the shaper cutter 91.

In the deformed state of the ring gear 20, the shaper cutter 91 generates the gear teeth having the desired value of base pitch equal to that of the planet pinion 50. Other related methods of machining of thin-wall (flexible) ring gears 20 are to be contemplated based on the disclosed concept.

In cases manufactured with a certain intentional elastic deformation, the condition of contact should be satisfied in the deformed state of the part surface being machined.

The intentional elastic deformation of a work for manufacturing purposes is observed when machining flex-spline that is an essential machine element of a harmonic drive as well as in other applications.

The capability to alter the orientation of the unit normal vector to the part surface is limited, as elastic deformation of most of materials to be machined commonly is small. However, such a capability is feasible, and it affects the generation of the part surface which is of principal importance and should be taken into account.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A planetary gear set comprising:
a sun gear;
planet gears that mesh with the sun gear;
a ring gear that extends around the sun gear and the planet gears and meshes with the planet gears, the ring gear including an annular body;
each of the sun gear, the planet gears, and the ring gear having teeth that mesh together;
the annular body of the ring gear constructed from an elastically deformable material and having a first shape when no load is applied to the ring gear and a radially deformed second shape when a load is applied to the ring gear, the teeth of the ring gear having a first base pitch in the first shape and a different second base pitch in the second shape;
the second base pitch of the ring gear being equal to base pitches of the sun gear and the planet gears.

2. The planetary gear set of claim 1, wherein axes of the sun gear, the planet gears, and the ring gear are parallel.

3. The planetary gear set of claim 1, further comprising a carrier that includes axial shafts that each extend through an interior of one of the planet gears.

4. The planetary gear set of claim 1, wherein the ring gear includes a greater operating pitch diameter in the second shape than in the first shape.

5. The planetary gear set of claim 1, wherein the teeth of the ring gear are based on an operating pitch diameter of the second shape to accommodate for deflection.

6. A planetary gear set comprising:
a sun gear;
planet gears that mesh with the sun gear;
a ring gear that extends around the sun gear and the planet gears and meshes with the planet gears, the ring gear including an annular body;
each of the sun gear, the planet gears, and the ring gear including teeth that mesh together;
the annular body being elastically deformable under an operating load;
the base pitch of the deformed ring gear being equal to base pitches of the sun gear and the planet gears.

7. The planetary gear set of claim 6, wherein the annular body includes a first nominal shape and a second deformed shape under the operating load.

8. The planetary gear set of claim 7, wherein a radius of curvature of the ring gear is greater in the second deformed shape than in the first nominal shape.

9. The planetary gear set of claim 7, wherein the ring gear includes a greater operating pitch diameter in the second deformed shape than in the first nominal shape.

10. The planetary gear set of claim 6, wherein axes of the sun gear, the planet gears, and the ring gear are parallel.

11. The planetary gear set of claim 6, further comprising a carrier that includes axial shafts that each extend through an interior of one of the planet gears.

12. A planetary gear set comprising:
a sun gear;
planet gears that mesh with the sun gear;
each of the sun gear and the planet gears maintaining their shapes under an operating load;
a ring gear that extends around the sun gear and the planet gears and meshes with the planet gears, the ring gear including a body that flexes radially under the operating load, the ring gear having an operating pitch diameter under the operating load that is greater than a nominal pitch diameter without the operating load;
each of the sun gear, the planet gears, and the ring gear having teeth that mesh together;
the tooth profile of the ring gear being based on the operating pitch diameter to accommodate the deflection;
the teeth of the sun gear, the planet gears, and the ring gear under the operating load having equal base pitches.

13. The planetary gear set of claim 12, wherein the ring gear is constructed from a material such that the ring gear elastically deforms under the operating load.

14. The planetary gear set of claim 12, wherein axes of the sun gear, the planet gears, and the ring gear are parallel.

15. The planetary gear set of claim 12, further comprising a carrier that includes axial shafts that each extend through an interior of one of the planet gears.
